(19) United States
(12) Patent Application Publication
(10) Pub. No.: US 2018/0253792 A1
(43) Pub. Date: Sep. 6, 2018

(54) MANAGEMENT OF ELECTRONIC CONTENT SHARING

(71) Applicants: David P. Conway, Los Altos, CA (US); Helena Roeber, Palo Alto, CA (US)

(72) Inventors: David P. Conway, Los Altos, CA (US); Helena Roeber, Palo Alto, CA (US)

(73) Assignee: Google Inc., Mountain View, CA (US)

(21) Appl. No.: 13/467,860

(22) Filed: May 9, 2012

Related U.S. Application Data
(60) Provisional application No. 61/484,090, filed on May 9, 2011.

(51) Int. Cl. G06Q 40/02; G06F 9/451

(52) U.S. Cl. CPC G06Q 40/02; G06F 9/451

(57) ABSTRACT

Methods, systems, and apparatus, including computer programs encoded on computer storage media, provide for one or more items of electronic content, or selected portions thereof, to be loaned or shared directly from one device to another device. A share event may be initiated by tapping, bumping, or other physical contact between the two devices, or by proximity of the two devices. During the share event, and/or at other times, one or more offers to purchase share opportunities associated with the item of electronic content may be presented on the loaner's device and/or the recipient's device. If a share request is approved, a copy of the item(s) of electronic content may be transferred directly from the loaner's computing device to the recipient's computing device, or may be transferred from a server at a later time.

### RELATED APPLICATION

This application claims the benefit of priority to U.S. Provisional Application No. 61/484,090, filed May 9, 2011, the entire content of which is incorporated by reference herein.

### BACKGROUND

A user may consume electronic content by, for example, watching a video recording, reading an electronic book, playing a video game, listening to music, or listening to an audio recording or ringtone. Digital versions of music, movies, books, games, and other electronic content may be purchased online and consumed on computers or other digital computing devices. These computing devices include digital music players, mobile phones, e-readers, tablet PCs, personal digital assistants, etc. Likewise, many applications (“apps”) for such devices are also available online.

### SUMMARY

In one example, the disclosure is directed to a computer-implemented method comprising detecting initiation of a share event during which at least one item of electronic content is to be shared between a loaner computing device and a recipient computing device, wherein the share event is initiated through relative physical movement of the loaner computing device and the recipient computing device in a manner by which an intent to initiate the share event may be inferred, providing an offer to purchase one or more share opportunities associated with the item of electronic content during the share event, the one or more share opportunities providing one or more corresponding opportunities to share the item of electronic content with another computing device, receiving an indication as to whether or not the offer has been accepted, and approving the share event based upon a number of share opportunities associated with the item of electronic content owned by one of the loaner or the recipient prior to initiation of the share event or purchased by one of the loaner or the recipient during the share event.

The computer-implemented method may further include transferring a copy of the item of electronic content directly between the loaner computing device and the recipient computing device after the share event is approved. The computer-implemented method may further include causing, before the transfer of the item of electronic content from the loaner computing device to the recipient computing device, a payment to be processed. The offer may be provided before the transfer of the item electronic content from the loaner computing device to the recipient computing device. Multiple offers to purchase one or more share opportunities associated with the item of electronic content on the loaner computing device may be provided during the share event.

In another example, the disclosure is directed to a computer-readable storage medium comprising instructions that cause one or more processors to detect initiation of a share event during which at least one item of electronic content is to be shared between a loaner computing device and a recipient computing device, wherein the share event is initiated through relative physical movement of the loaner computing device and the recipient computing device in a manner by which an intent to initiate the share event may be inferred, provide an offer to purchase one or more share opportunities associated with the item of electronic content during the share event, the one or more share opportunities providing one or more corresponding opportunities to share the item of electronic content with another computing device, receive an indication as to whether or not the offer has been accepted, and approve the share event based upon a number of share opportunities associated with the item of electronic content owned by one of the loaner or the recipient prior to initiation of the share event or purchased by one of the loaner or the recipient during the share event.

Other embodiments of these aspects include corresponding systems, apparatus, and computer programs, configured to perform the actions of the methods, encoded on computer storage devices.

The details of one or more examples of the subject matter described in this specification are set forth in the accompanying drawings and the description below. Other potential features, aspects, and advantages of the will become apparent from the description, the drawings, and the claims.

### BRIEF DESCRIPTION OF THE DRAWINGS

FIG. 1 is a diagram of an example system that may manage sharing of electronic content.

FIG. 2 is a diagram that illustrates an example of sharing of electronic content between two user mobile computing devices.

FIG. 3 is a diagram that illustrates an example of sharing of electronic content between three user mobile computing devices.

FIG. 4A is a flowchart of an example process that may manage sharing of electronic content.

FIG. 4B is a flowchart of another example process that may manage sharing of electronic content.

FIGS. 5A-5D are diagrams that illustrate example user interfaces.

FIGS. 6A-6D are diagrams that illustrate additional example user interfaces.

FIGS. 7A-7B are diagrams that illustrate additional example user interfaces.

### DETAILED DESCRIPTION

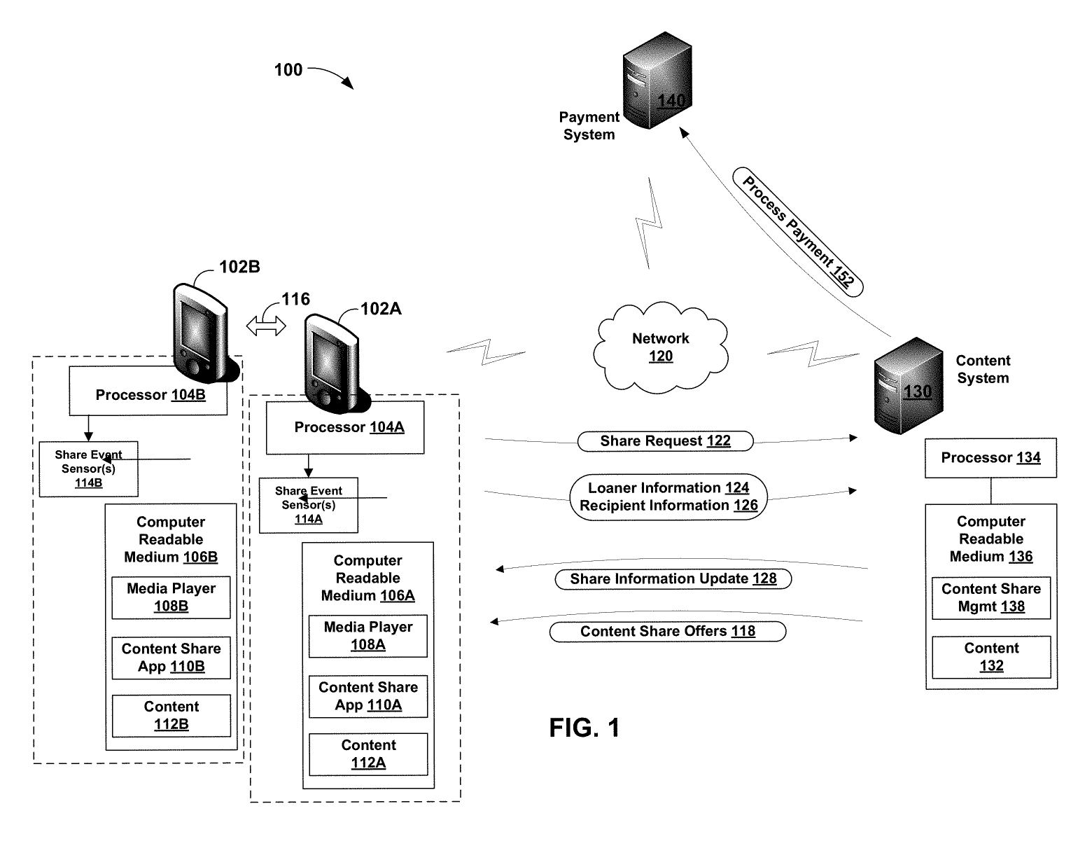

FIG. 1 is a diagram of an example system 100 that may manage sharing of electronic content between two computing devices 102. In FIG. 1, a content publication system 130 (or another system working in tandem with the content publication system 104) manages sharing of electronic content between two computing devices 102, such as mobile computing device 102A and mobile computing device 102B. Although in this example the computing devices 102A and 102B are mobile computing devices, it shall be understood that one or both of computing devices 102 could also be any one of a digital music player, a mobile phone, an e-reader, a tablet PC, a personal digital assistant, a laptop computer, a desktop computer, etc.

A content sharing application 110, such as content sharing application 110A and/or 110B running on a user's computing device, such as mobile device 102A and/or 102B, respectively, and a content sharing management application 138 running on the content publication system 130 permit electronic content to be transferred or “loaned” directly from one computing device to another computing device.

Mobile device 102A, for example, may include a processor 104A and a computer readable medium 106A. The computer readable medium 106A may store one or more applications, such as a media player application 108A and a content sharing application 110A. The computer readable medium 106A may also store one or more items of electronic content 112A, e.g., movies or other videos, ringtones, songs or other audio files, photographs, electronic wallpaper, electronic books, etc. Media player application 108A may be configured to play one or more item of electronic content 112A during a defined consumption period, which may be a rental period, a viewing period, a listening period, or other period in which the content publication system 130 allows the mobile device 102. Mobile device 102B may likewise include a processor 104B, a computer readable medium 106B, a media player 108B, a content sharing application 110B, and electronic content 112B.

Computing devices 102A and 102B may be the same type of computing device or they may be different types of computing devices. For example, mobile devices 102A and 102B may both be mobile phones, digital music players, e-readers, tablet PCs, laptop, personal digital assistants, etc. As another example, mobile devices 102A and 102B may be different types of mobile devices. That is one of devices 102A or 102B may be one of a mobile phone, a digital music player, an e-reader, a tablet PC, a laptop, a personal digital assistant, etc., while the other device 102A or 102B may be one of the other types of mobile device. In addition, even if both mobile devices 102A and 102B are the same type of mobile device (they are both mobile phones, for example), they need not be the same make or model of the mobile device. In another example, one or both of computing devices 102 need not be a mobile computing device, but could instead be a desktop computer or other “non-mobile” type of computing device.

In one example, system 100 permits electronic media to be transferred or “loaned” from one device to another by tapping or proximity. For example, assume one person wants to loan another person the eBook they finished last week. The loaning party (the “loaner”) may select the eBook in their device's library, give a share command, and then tap it to the receiving party's (the “recipient”) device.

There are several possible mechanisms to manage such sharing of electronic content. For example, the loaner may not be permitted to consume the eBook until the recipient returns it (as with a real book), or the loaner may have a license for two copies so that they plus one other person could consume it simultaneously, or the loaner may have a license for unlimited loans of the eBook, etc. The loaner may have a pool of licenses that can be used on multiple media titles and not tracked per title. The pool of licenses could exist for a particular online store (such as Google Play, Amazon, iTunes, etc.), a particular group of online stores, a particular publisher, content provider, or software developer. The share opportunities may or may not have expiration dates. Content share offers (that is, offers to purchase share opportunities associated with one or more items of electronic content) may be presented periodically by online stores or by content owners as a form of promotion. This may encourage more sharing or may help to prevent viral spread (unauthorized copying and/or sharing) of their titles.

The system 100 may include automatic reminders to return the title at end of a loan period (for example, either by automatic return or manual return by tapping or proximity); the title may be automatically returned (or the recipient may be prompted to return) when consumption finishes; the loaner may be able recall the loan any time; the recipient may be able, by tapping or proximity, to loan the title to another person; the original loaner may be notified and be provided with the opportunity to approve or disprove the additional loan, or revoke the original loan, etc.

The initial purchase of the item of electronic content may include granting an ownership right or interest in the electronic content to the purchaser, allowing the purchaser to share the electronic content an unlimited number of times. The initial purchase of electronic content may also include granting a more limited right, such as a right for the purchaser to share/loan all or some portion of the item of electronic content on one or more future occasions.

Content share offers may be provided to the initial purchaser and/or to recipients of shared copies of electronic content, thus providing them with further opportunities to purchase additional sharing of the electronic content.

Referring again to FIG. 1, system 100 includes at least two user computing devices, such as computing device 102A and computing device 102B, between which at least one item of electronic content is to be shared. System 100 further includes a payment system 140 and a content publication system 130, connected by way of one or more networks 120. The content publication system 130 may be any system that publishes content, such as a media server or a cable network head-end device. The networks 120 may include a private network, such as an intranet, a public network, such as the Internet, or some combination thereof. The client devices 102 may be, for example, laptop computers, tablet computing devices, digital picture frames, desktop computers, televisions, set top boxes, mobile phones, PDA (Personal Digital Assistant), smart phones, other mobile or stationary computing devices, or any other suitable device or combination of devices.

Assume the user of device 102A (also referred to herein as the “loaner”) wishes to share an item of electronic media with the user of device 102B (the “recipient”). To do so, a so-called “share event” may be initiated between the loaner's computing device 102A (the “loaner device”) and the recipient's computing device 102B (the “recipient device”). In some examples, the share event may be initiated through the relative physical movement of the loaner device and the recipient device.

For example, devices 102A and 102B may be “tapped” or “bumped” together to initiate a share event. As another example, the hands of the loaner and the recipient may be tapped or bumped while holding devices 102A and 102B, respectively, to initiate a share event. As another example, devices 102A and 102B may be brought into proximity with each other to initiate a share event. In some examples, both the loaner device 102A and the recipient device 102B are physically moved to initiate a share event. In other examples, only one of the loaner device 102A or the recipient device 102B is physically moved to initiate a share event.

To detect initiation of a share event, each of devices 102A and 102B may include one or more share event sensor(s) 114A and 114B, respectively. Share event sensors 114 may detect, for example, bumps or taps that result from device-to-device physical contact or from contact of the user's hands while holding the device. Alternatively, share event sensors 114 may detect physical proximity of the two devices that is sufficiently close so as to infer intent to initiate a share event. Initiation of the share event, by whatever means, is indicated by arrow 116.

In the case that a share event is initiated by physical contact (tap or bump) of the devices (or the user's hands), event sensors 114 may detect may detect a single tap, a particular tap pattern, the number of physical contacts, the location and/or direction of each physical contact, a time duration between a physical contact and a subsequent physical contact, a force associated with the physical contact, and/or other means of detecting initiation of a share event.

Share event sensors 113 may include, for example, an accelerometer, a gyroscope, a magnetometer and/or a contact-sensitive sensor (e.g., an electric field sensor, a surface conduction sensor, a pressure/force sensor, a vibration sensitive sensor, etc.) to detect a physical contact. In the case that a share event is initiated by proximity, share event sensors 114 may include a proximity detector such as a capacitive, photoelectric, inductive, infrared, or other type of proximity detector. It shall be understood that any type of contact or proximity detectors known in the art may be used to sense the initiation of a share event, and that the disclosure is not limited in this respect.

Content share application 110A and/or 110B receive share event sensor data from the share event sensors 114A and 114B, respectively. Content share applications 110A and/or 110B may communicate share event sensor data with each other. This communication may be uni-directional or bi-directional. The share event data may communicated between from one device to the other device, or between devices, using, for example, near field communication (NFC), WiFi, Bluetooth, or other short range communication technology. One or both of the content share applications 11A and/or 110B may then analyze the share event sensor data from both devices to determine whether a share event has been initiated. For example, content share application 110 may be able to discriminate between the normal bumping and jostling that occur during everyday use and a bump or tap with another device intended to initiate a share event.

Once a share event has been initiated, loaner device 102A sends a share request 122 to share a particular item of electronic content to the content publication system 130. For example, the user of the device 102A (the loaner) may request to loan a copy of a movie or other video recording, book, software item, online periodical, audio recording, or video game to the user of device 102B (the recipient). The share request for the item of electronic content may be generated, for example, as a result of calling up content share application 110A on device 102A, selecting the desired item of electronic content from an onscreen menu, and then initiating a share event by tapping devices 102A and 102B together or by bringing devices 102A and 102B into proximity with each other. In other examples, the recipient device 102B may send the share request, or both the loaner device 102A and the recipient device 102B may send a share request.

The share request 122 is transmitted over the network 120 and is received by the content publication system 130. In some implementations, the request 122 may include an indication of a desired start time and a desired stop time for an initial consumption period for the item of electronic content. For example, the share request 122 may include a desired start date and time, and a desired end date and time, or the share request 122 may include a desired start date and time and a desired duration.

The content publication system 130 may determine a price associated with the sharing of the requested item of electronic content, and may submit a process payment request 152 to the payment system 140. As described in more detail below, in addition to or alternatively to submitting a process payment request to the payment system at the time of the share event, the content publication system 130 may submit a process payment request at other appropriate times, such as at the time of initial purchase or rental of an item of electronic content, at a time when the loaner purchases additional share opportunities, at a time when the recipient purchases one or more share opportunities, etc. The payment process request may indicate that the loaner (that is, the user of device 102A) or a different user, such as the user of device 102B, is to be charged.

As another example, the content publication system 130 may determine a start time and a stop time for recipient to consume the shared item of electronic content, without regard to or in the absence of the loaner's desired start and stop times. After the start time and stop time and have been determined, the content publication system 130 may send an indication of a start time of the initial consumption period, and an indication of the stop time of the initial consumption period, to the client device 102A and/or 102B. The stop time may be an end date and time, or may be a duration value defined relative to the start time.

The content publication system 130 (or a system working in tandem with the content publication system 130) determines whether to approve the share request. In addition to the share request 122, loaner information 124 and recipient information 126 are also transmitted to the content publication system 130. The content share management application receives the share request 122, loaner information 124, and recipient information 126 and performs and analysis to determine whether the requested share event should be approved.

For example, the content publication system 130 may determine the loaner has purchased one or more share opportunities associated with the item of electronic content prior to initiation of the share event, or if the loaner has purchased an unlimited right to share the item of electronic content.

For example, the content share management application 138 may include stored content sharing information associated with the loaner and/or the recipient. For example, as will be described in more detail below, the content sharing information associated with the loaner may include information concerning whether the loaner had previously purchased one or more share opportunities associated with the item of electronic content. If the loaner has previously purchased one or more share opportunities associated with the item of electronic content, the share request may be approved. If the loaner did not previously purchase one or more share opportunities associated with the item of electronic content, the share request may not be approved. In addition or alternatively, if the loaner did not previously purchase one or more share opportunities associated with the item of electronic content, the content publication system 130 may present an offer to the loaner to purchase one or more share opportunities associated with the item of electronic content.

In some examples, the share opportunities may be associated with a particular item of electronic content. As another example, the share opportunities may be associated with a group of items of electronic content to which the particular item of electronic content belongs. The share opportunities may or may not have expiration dates.

For example, the loaner may have accepted an offer that allows them to loan out (share) four additional copies of a particular item of electronic content. In this example, the content publication system 130 may identify whether the loaner has initiated three or fewer subsequent share events for that item of electronic content. In this example, if the loaner has initiated three or fewer share events for that item of electronic content, the content publication system 130 may approve the share request, and if the loaner has already initiated four subsequent share requests for that item, then the content publication system 130 may not approve the share request.

As another example, the loaner may have accepted an offer that allows them to loan out (share) four copies of any item of electronic content belonging to a certain group of items. In this example, the content publication system 130 may identify whether the loaner has initiated three or fewer subsequent share events for the group of items of electronic content to which the selected item of electronic content belongs. In this example, if the loaner has initiated three or fewer share events for that group of items of electronic content, the content publication system 130 may approve the share request, and if the loaner has already initiated four subsequent share requests for that group of items, then the content publication system 130 may not approve the share request.

If the share request is approved by the content share management application 138, a copy of the item of electronic content may be communicated directly from device 102A to device 102B. Communication of the item of electronic content from one device to another device may be accomplished by near field communication (NFC), WiFi, Bluetooth, or any other short range communication technology. Alternatively, communication of the item of electronic content may be accomplished from the content system 130 to the recipient device 102B.

Alternatively or in addition, the loaner's purchased share opportunities associated with each item of electronic content purchased/rented by the loaner may be stored locally on device 102A. In that case, upon detection of the initiation of a share event, content share application 110A may determine whether the loaner may share a copy of the item of electronic content by accessing the locally stored information regarding purchased share opportunities.

The content publication system 130 sends a share information update 128 to the loaner's device 102A. The share information update may include, for example, information concerning a remaining number of share opportunities related to the loaner, related to the shared item of electronic content, etc. For example, if the loaner had purchased a fixed number of opportunities to share the item of electronic content (“5” opportunities, for example), the share information update 128 may include a decreased number of remaining share opportunities (“4” opportunities, in this example).

The content publication system 130 (or another system working in tandem with the content publication system 130) may also provide one or more content share offers 118 to device 102A. For example, an offer 118 may provide the loaner with an opportunity to purchase one or more additional content share opportunities. One or more offers 118 may be displayed on, for example, an interface associated with device 102A and/or 102B.

The offers 118 may be displayed, for example, before, during, or after the consumption of the item of electronic content by either the loaner or the recipient, or both. For example, one or more offers 118 may be displayed in response to selection of a control included in a playback control menu of a media player, such as media player 108A or media player 108B. The offers 118 may be displayed, for example, in response to selection of a pause, rewind, or fast-forward control selected on the playback control menu of the media player 108, in response to the selection of a control on a remote control device, or in response to some other playback control mechanism.

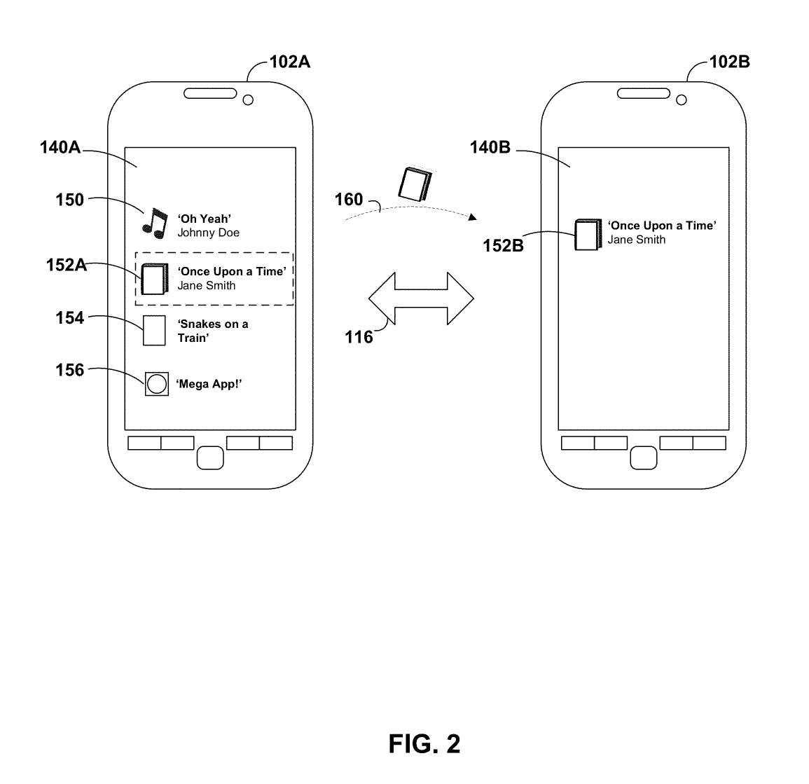

FIG. 2 is a diagram that illustrates an example sharing of electronic content between two mobile devices 102A and 102B. In this example, loaner device 102 A includes a screen display 140A on which a list of electronic content is displayed. In this example, the electronic content includes a song represented by icon 150 (“Oh Yeah” by Johnny Doe), a book represented by icon 152 (“Once Upon a Time” by Jane Smith), a movie represented by icon 154 (“Snakes on a Train”) and an application represented by icon 156 (“Mega App”). More or fewer items of electronic content may be displayed, and other types of electronic content may also be displayed. In this example, the book 152 has been selected for sharing (as indicated by the dashed line) and a share event between devices 102A and 102B has been initiated (as indicated by arrow 116). Assuming the share event is approved (such as described above with respect to FIG. 1), a copy of the book represented by icon 152A may be transferred directly from device 102A to device 102B during the share event. This direct transfer from device 102A to device 102B is represented by dashed line 160. As mentioned above, the communication between devices may be by near field communication (NFC), WiFi, Bluetooth, or other short range communication technology. After a copy of the book has been successfully transferred to device 102B, an icon 152B representative of the copy of the book stored on device 102B may be displayed on screen 140B.

In another example, if the recipient computing device contains insufficient storage space to receive the item of the electronic content during the share event, a copy of the item of electronic content may be transferred from a server computer (such as the content system 134, another server computer or an intermediate computing device) to the recipient computing device at a time subsequent to the share event. This may permit the recipient to receive the item of electronic content at a later time even if their device does not have enough free space available at the time of the share event. In this way, at a time subsequent to the share event when sufficient memory space if available on the recipient device, the item may be obtained from a server without having to re-initiate a share event. The copy of the item of electronic content may also be transferred from a server computer at a later time for other reasons, such as by choice of the loaner or recipient, if an error occurred during transfer from the loaner device to the recipient device, etc.

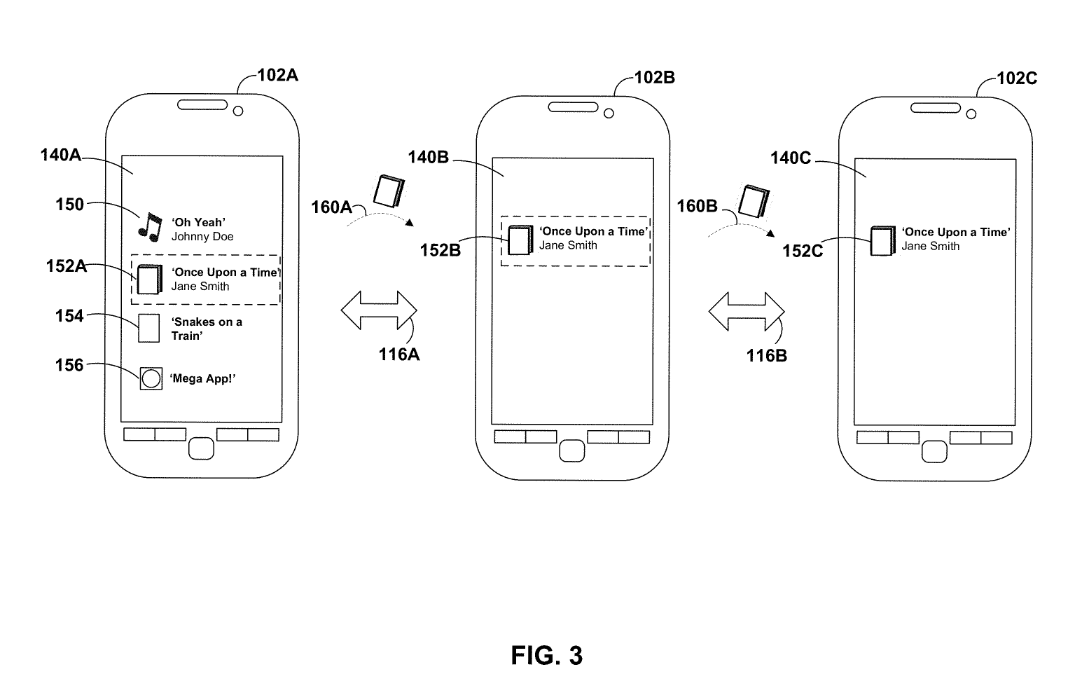

FIG. 3 is a diagram that illustrates sharing of electronic content between three mobile devices 102A, 102B, and 102C. A first share event indicated by dashed line 160A takes place between devices 102A and 102B as described above with respect to FIG. 2. Subsequently, a user of device 102C wishes to borrow a copy of the item of electronic content represented by icon 152B (in this case, the book “Once Upon a Time” by Jane Smith) that is stored on first recipient's device 102B. In this example, the icon 152B representative of the book has been selected for sharing (as indicated by the dashed line) and a share event between devices 102B and 102C has been initiated (as indicated by arrow 116B). The share event between devices 102B and 102C may be referred to as a secondary share request.

At this point the content sharing management application 138 of content publication system 130 (see FIG. 1) may present an offer on device 102A that provides the loaner with an opportunity to either approve or not approve the secondary share request. As another example, the content publication system 130 may present an offer on device 102A that provides the loaner with an opportunity to revoke the original loan of the item of electronic content to device 102B.

The content sharing management application 138 of content publication system 130 (see FIG. 1) may also determine whether to approve the secondary share request between devices 102B and 102C. For example, the content publication system 130 may determine whether the first recipient (the user of device 102B) has purchased one or more share opportunities associated with the item of electronic content. If the first recipient has not purchased one or more content share opportunities associated with the item, the content publication system 130 may not approve the secondary share request between devices 102B and 102C. If the first recipient has purchased one or more content share opportunities associated with the item, the content publication system 130 may approve the secondary share request.

As another example, the content publication system 130 may present one or more content share offers 118 (see FIG. 1) on device 102B. For example, an offer 118 presented on device 102B may provide the first recipient with an opportunity to purchase one or more content share opportunities for the item of electronic content. As another example, an offer 118 presented on device 102C may provide the secondary recipient with an opportunity to purchase a borrowing opportunity for the item of electronic content from device 102B. One or more offers 118 may be displayed on, for example, an interface associated with device 102B and/or 102C.

If the share event between devices 102B and 102C is approved, a copy of the item of electronic content (in this example the book represented by icon 152B) is transferred directly from device 102B to device 102C. This direct transfer from device 102B to device 102C is represented by dashed line 160B. After a copy of the book has been successfully transferred to device 102C, an icon 152C representative of the copy of the book stored on device 102C may be displayed on screen 140C.

In connection with the secondary share request, the content publication system 130 may also send a process payment request to the payment system 140 for processing a payment associated with the secondary sharing of the item of electronic content. For example, if the first recipient has accepted a content share offer to purchase one or more share opportunities associated with the item of electronic content, the content publication system 130 may send a process payment request to the payment system 140 for processing a payment from the first recipient device 102B associated with the secondary share request. As another example, if the secondary recipient has accepted a content share offer to borrow the item of electronic content from device 102B, the content publication system 130 may send a process payment request to the payment system 140 for processing a payment from the secondary recipient device 102C associated with the secondary share request.

Once an item of electronic content has been shared with a recipient (that is, copied onto the device of another user), the recipient may consume (e.g., view, watch, listen, play, or otherwise interact with) the item of electronic content. For instance, depending upon the conditions associated with the share event, the recipient may consume the item of electronic content at least once, once during a consumption period, a predetermined number of times during a consumption period, an unlimited number of times until the loan is revoked, an unlimited number of times, a predetermined number of times until the item of electronic content is loaned to a secondary recipient, etc.

Although the examples described with respect to FIGS. 2 and 3 are directed to the sharing of an electronic version of a book, it shall be understood that the electronic content sharing management techniques described herein may be used to manage sharing/loaning of any form of electronic content, including books, music, movies, games, audio files, video files, applications (“apps”), software, wallpapers, photos, ringtones, and other forms of electronic content.

In addition, although the examples described with respect to FIGS. 2A and 3 are directed to the sharing of a single item of electronic content, it shall be understood that the content sharing management techniques described herein may be used to manage sharing/loaning of multiple items of electronic content in a single share event.

Also, although the examples described with respect to FIGS. 2A and 3 are directed to either a single share event (FIG. 2) or to two consecutive share events (a first share event and a secondary share event) for a single item of electronic content (FIG. 3), it shall be understood that the content sharing management techniques described herein may also be used to manage three or more consecutive share events for a single item of electronic content.

Although FIG. 1 illustrates the content publication system 130 providing items of electronic content share offers, in some implementations this functionality may be performed by two or more discrete systems. For example, the content publication system 130 may service requests for items of electronic content, and a separate content share management system may monitor content share requests and provide content share offers to users at appropriate times.

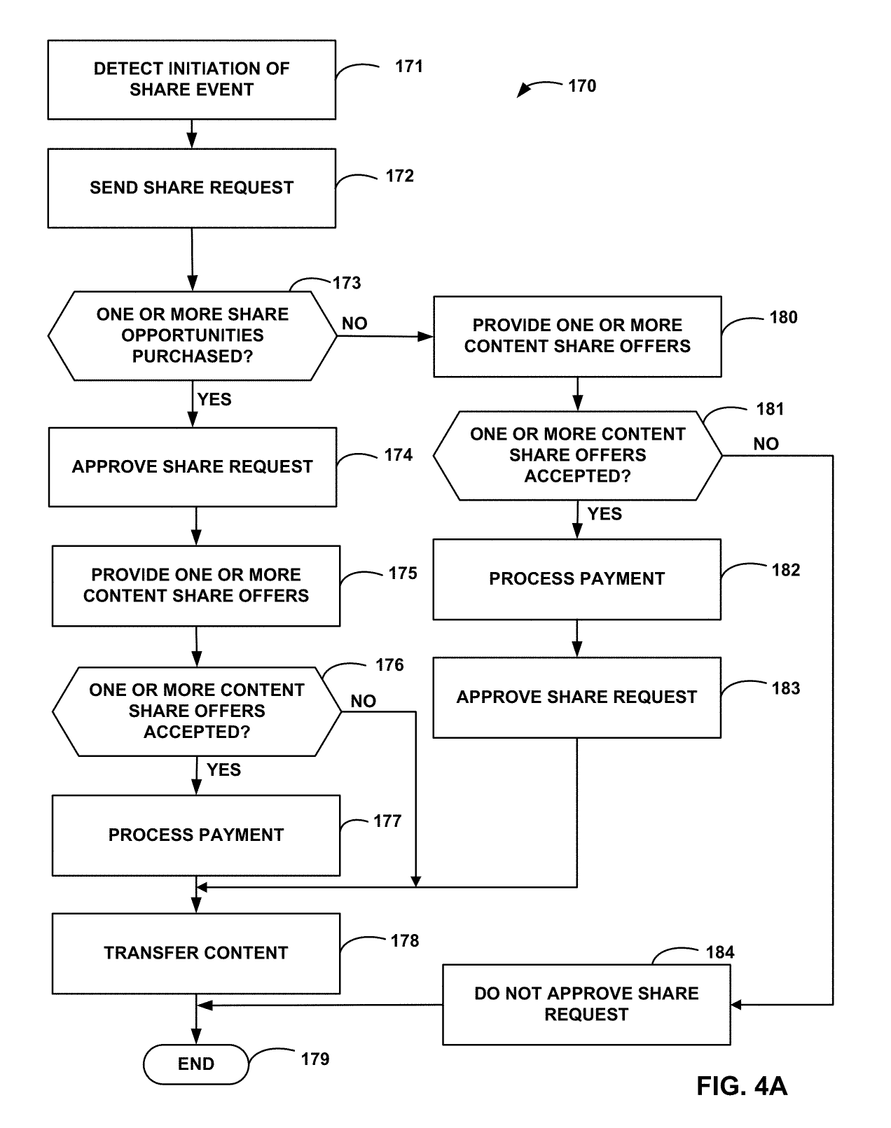

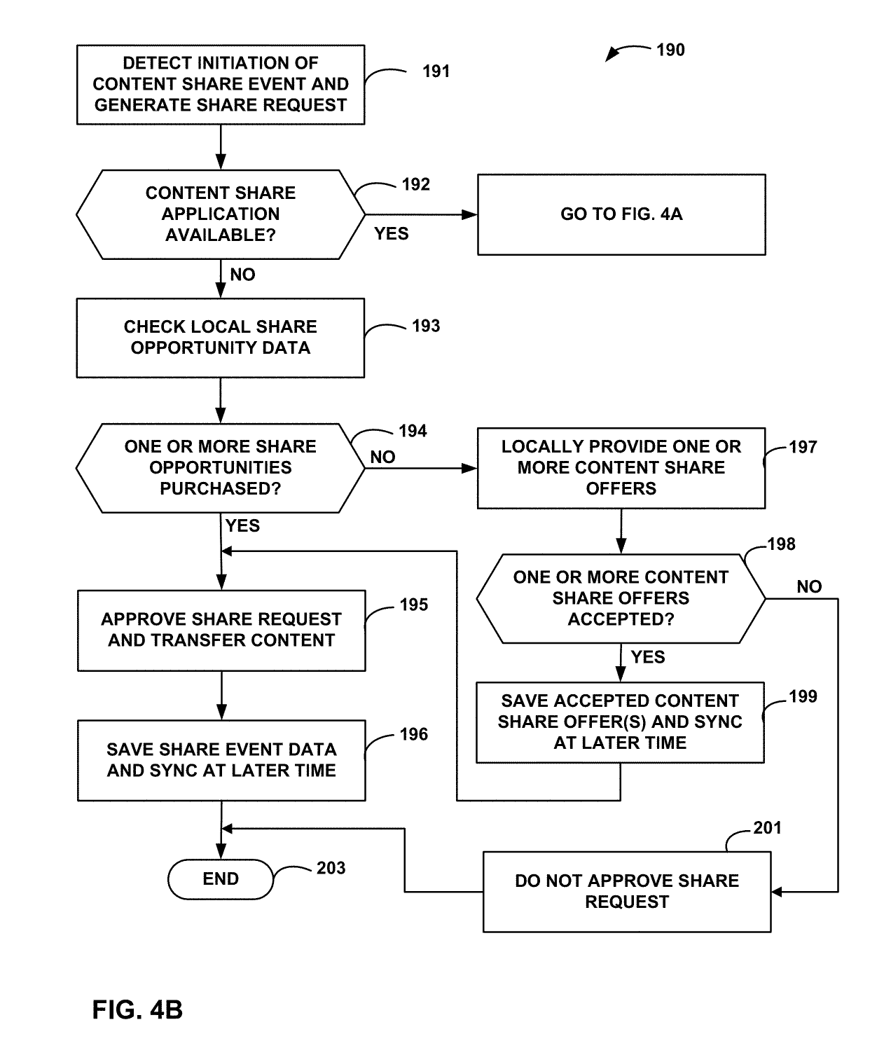

FIG. 4A is a flowchart of an example process 170 that may manage sharing of electronic content. Process 170 may be referred to as a “server-managed” share event. Process 170 includes detecting initiation of a share event between a loaner device and a recipient device for at least one item of electronic content (171) and sending a content share request (172). Upon receipt of the share request, the process may determine whether one or more share opportunities associated with the item of electronic content have been previously purchased (173). If so, the share request may be approved (174). One or more content share offers may be provided (175). If one or more of the content share offers are accepted (176), a payment associated with the content share offer(s) is processed (177). The item(s) of electronic content associated with the share request may then be transferred from the loaner device to the recipient device (178). This ends the share event (179).

If, on the other hand, the loaner had not previously purchased any share opportunities associated with the item of electronic content (174), one or more content share offers may be provided (180). If one or more of the content share offers are accepted (181), a payment associated with the content share offer(s) is processed (182). The share request may then be approved (183) and the item(s) of electronic content associated with the share request may then be transferred from the loaner device to the recipient device (178). This ends the share event (179). Alternatively, if one or more of the content share offers are not accepted (181), the share request is not approved (184), and the share event ends (179).

FIG. 4B is a flowchart of another example process 190 that may manage sharing of electronic content. Process 190 may be referred to as a “peer-managed” share event. Such a share event may take place when communication with the share management application (such as 138 in FIG. 1) is not available. For example, process 190 of FIG. 4B may be used when the loaner and recipient wish to share one or more items of electronic content while on an airplane, when the content system server (such as 130 in FIG. 1) is down, when cellular or Wi-Fi service is unavailable, or at any other time when communication with the share management application is not possible or practical.

Process 190 includes detecting initiation of a share event between a loaner device and a recipient device for at least one item of electronic content (190) and determining whether communication with the content share application is available (192). If so, then process 170 of FIG. 4A may be followed. If not, the loaner device may refer to locally stored share opportunity data associated with the loaner device to determine whether one or more share opportunities associated with the item(s) of electronic content have been previously purchased (193). If so (194), the share request may be approved and the item(s) of electronic content associated with the share request may then be transferred from the loaner device to the recipient device (195). The loaner device may save the data associated with the share event (e.g., the loaner and recipient identification information, the item(s) of electronic content associated with the share event, etc.) to be synced with the content share management application at a later time when communication becomes available (196). This ends the share event (203).

Alternatively, if the loaner has not previously purchased one or more share opportunities associated with the item of electronic content (194), one or more locally generated content share offers may be provided (197). These offers may be provided to the loaner, the recipient, or both. If one or more of the content share offers are accepted (198), the loaner and/or the recipient device, as appropriate, may save the data associated with the content share offer to be synced with the content share management application at a later time (199). The share request may be approved and the item(s) of electronic content associated with the share request may then be transferred from the loaner device to the recipient device (195). The loaner and/or the recipient device may save the data associated with the share event (e.g., the loaner and recipient identification information, the item(s) of electronic content associated with the share event, etc.) to be synced with the content share management application at a later time when communication becomes available (196). This ends the share event (203).

If, on the other hand, none of the content share offers are accepted (198), the share request is not approved (201), and the share event ends (203).

In another example, if the recipient computing device contains insufficient storage space to receive the item of the electronic content during the share event, a copy of the item of electronic content may be transferred from a server computer (such as the content system 134, another server computer or an intermediate computing device) to the recipient computing device at a time subsequent to the share event. This may permit the recipient to receive the item of electronic content at a later time even if their device does not have enough free space available at the time of the share event. In this way, at a time subsequent to the share event when sufficient memory space if available on the recipient device, the item may be obtained from a server without having to re-initiate a share event.

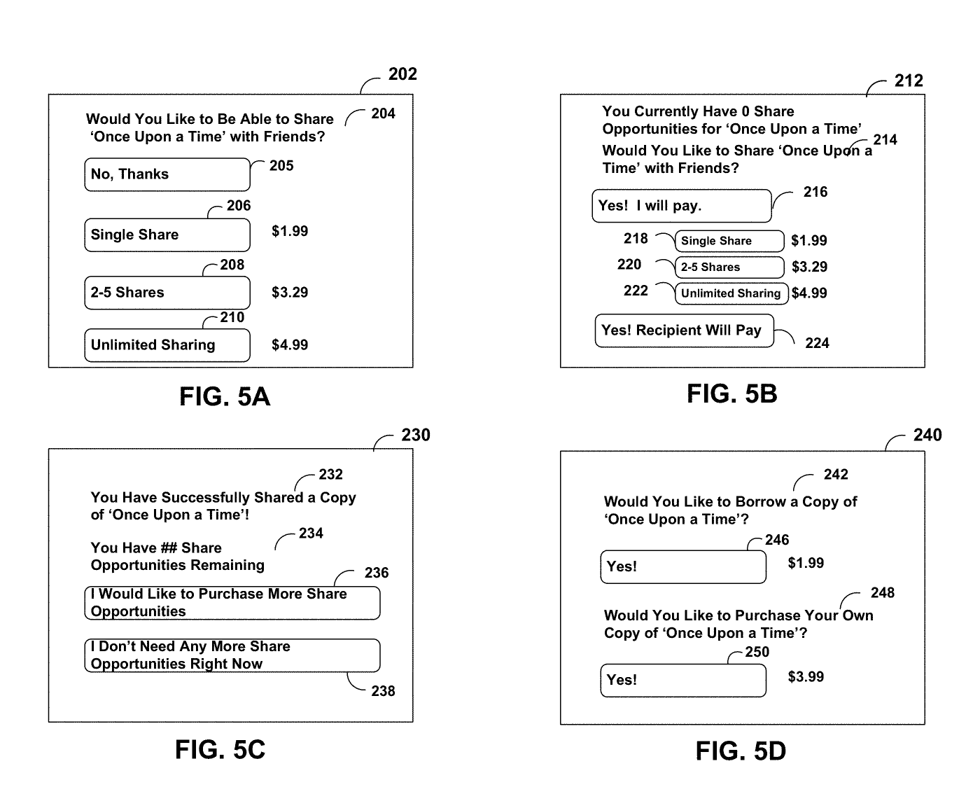

In general, at the time a user initially purchases one or more items of electronic content, the content publication system may present the user with an offer to purchase one or more opportunities to share, or loan, the item or items of electronic content with others. In effect, the user is presented with an offer to purchase a license to share the item or items with one or more other users. For example and as shown in FIG. 5A, an offer 204 may be displayed in an interface 202 on a user's device at the time of purchase of an item of electronic content. In this example, the user has purchased the electronic book, “Once Upon a Time.” An offer, such as offer 204, may be presented to the user asking them if they would like to share copies of “Once Upon a Time” with friends. The offer 204 may include one or more options for response. For example, in FIG. 5A the user may select a control such as control 204 (“No, Thanks) if they do not wish to purchase any share opportunities associated with the electronic book “Once Upon a Time” at this time. As another example, the offer may present one or more pricing options, and/or the price for an offer may be based on the specified quantity of share opportunities. For example, the price for a lower number of share opportunities may be lower than the price for a higher number of share opportunities. In this example, the offer presents three pricing options 206, 208 and/or 210 (a Single Share for $1.99, 2-5 Shares for $3.29, or Unlimited Shares for $4.99 in this example, respectively).

As another example, an offer (not shown) may be displayed on the loaner's device asking them if they would like to gift a copy of an item of electronic content to the recipient. The offer may include one or more options for response. For example, the loaner may select a control (“No, thanks) if they do not want to gift a copy of the item. The loaner may select a control (“Yes, $9.99) if they do want to gift a copy of the item to the recipient. The offer may permit the loaner to gift a new copy of the item or may permit them to gift their own copy of the item of electronic content. Different prices may be associated with each of these options.

Referring again to FIGS. 4A and 4B, processes 170, 190, respectively, may begin when initiation of a content share event between a loaner device and a recipient device for at least one item of electronic content is detected (171, 191). The item of electronic content may be, for example, a movie or other video recording, an audio recording, an electronic book, a whitepaper, a periodical, a video game, a software program, wallpaper, a mobile device application, or some other type of electronic content. Initiation of the content share event may be detected by share event sensors on each of the loaner device and the recipient device (such as share event sensors 114A and 114B on devices 102A and 10B as shown in FIG. 1). The share event sensor(s) detect a physical bump or tap between the two devices (or between hands of the users while holding the devices), or may detect physical proximity of the two devices. Data from the share event sensors is analyzed by a content share application running on one or both of the devices to determine whether a share event has been initiated, such as content share applications 110A and/or 110B on devices 102A and 102B as shown in FIG. 1).

Once initiation of the share event has been detected, and assuming communication with the content share management application is available, at least one of the loaner device or the recipient device generates and sends a content share request (e.g., 172 in FIG. 4A). Depending upon whether or not the loaner has previously purchased share opportunities associated with the item of electronic content, the share request may be approved or approving or disapproved. For example, if the user had previously purchased share opportunities associated with the item of electronic content, the share request may be approved. Alternatively, if the user had not previously purchased share opportunities associated with the item of electronic content, the share request may not be approved.

Regardless of whether the share request is approved or disapproved, the loaner and/or the recipient may be provided with one or more content share offers. For example, an offer presenting share opportunities associated with the item of electronic content may be displayed on the loaner's device when it is determined that the loaner had not previously purchased at least one share opportunity associated with the item of electronic content, or that the loaner has used up any previously purchased share opportunities. For example and as shown in FIG. 5B, an offer 214 may be displayed in an interface 212 on the loaner's device if it is determined that the loaner does not have any share opportunities for the item of electronic content. In this example, it was determined that the loaner currently does not have any share opportunities for the book “Once Upon a Time” and the offer 214 therefore asks them if they would like to share a copy of “Once Upon a Time” with friends. The offer 214 may include one or more options for response. For example, the price for an offer may be based on the specified quantity of share opportunities. For example, the price for a lower number of share opportunities may be lower than the price for a higher number of share opportunities. For example, in FIG. 5B the loaner may select a control such as control 216 (“Yes, I Will Pay”), and the offer may further present one or more pricing options 218, 220 and/or 222 (a Single Share for $1.99, 2-5 Shares for $3.29, or Unlimited Shares for $4.99 in this example, respectively).

As another example, the loaner may select a control such as control 224 (“Yes, Recipient Will Pay”) if the recipient is to pay for the loan. If control 224 is selected, an offer 242 such as shown in FIG. 5D may be displayed on an interface 240 on the recipient's device. Offer 242 (“Would You Like to Borrow a Copy of ‘Once Upon a Time’”) may present one or more options for response. For example, the recipient may select a control such as control 246 (Yes! $1.99) if the recipient would like to simply borrow a copy of the item of electronic content. Alternatively, the recipient may select a control such as control 250 (Yes! $3.99) if the recipient would like to purchase their own copy of the item of electronic content.

The price included in an offer may be dynamically determined. For example, a price may be based on when the offer is presented. For example, a price included in an offer presented to a user who does not have any available share opportunities associated with the item of electronic content may be higher than a price included in an offer presented to the user who does have available share opportunities associated with the item.

The offer details may be presented on the screen with the offer when the offer is presented. Alternatively, the user may select a control to view additional details about the offer 312.

If the loaner had previously purchased share opportunities associated with the item of electronic content, and/or if the loaner accepted a content share offer such as offer 214 (FIG. 5B) and/or if the recipient accepted a content share offer such as offer 242 (FIG. 5D), the share request will be approved, because at least one of the loaner or the recipient is in possession of a current share opportunity associated with the item of electronic content.

Returning again to FIGS. 4A and 4B, example processes 170 and 190 may further include determining whether the one or more content share offers were accepted (181, 198). For example, the user may select a control or a link included in or displayed with the offer to indicate acceptance of the offer. For example, and referring to FIGS. 5A-5D, the user may select control 206, 208, or 210 in FIG. 5A; control 216, 218, 220, 22, or 224 in FIG. 5B; control 236 in FIG. 5C; or control 246 or 250 to indicate acceptance of the offer 204, 214, 236, 242, or 248, respectively. Or, as another example, the user may select a different control included on an interface which presents offer details. Referring to FIG. 5A, the user may select control 205 to indicate non-acceptance of the offer 204. Referring to FIG. 5C, the user may select the control 238 to indicate non-acceptance of the offer 236.

Example process 170 further includes processing a payment associated with an acceptance of at least one of the content share offers (177, 182). For example, if an offer to purchase share opportunities, an offer for outright purchase of the item of electronic content, or other offer requiring payment is accepted, a payment associated with acceptance of the offer or offers is processed. In some examples, if multiple offers were accepted, a single transaction may be performed, rather than multiple transactions associated with each individual offer. The content sharing management system may wait, for example, until all possible offers have been presented during a share event and a response (e.g., acceptance or non-acceptance) has been received from the relevant user, before processing payment. In some examples, the payment is processed before a copy of the item of electronic content is transferred from the loaner device to the recipient device.

Example processes 170, 190 may further include transferring a copy of the at least one item of electronic content from the loaner device to the recipient device (178, 195). The transfer between devices may be accomplished using near field communication (NFC), WiFi, Bluetooth, or other short range communication technology.

Once the item or items of electronic content have been transferred from the loaner's device to the recipient's device, an offer may be presented to the loaner to purchase additional share opportunities associated with the item. For example and as shown in FIG. 5C, a statement 232 indicating that the share event was successful may be presented to the loaner on an interface 230 (“You Have Successfully Shared a Copy of ‘Once Upon a Time’”). In addition, a statement 234 indicating the loaner's currently number of remaining share opportunities may also be presented to the loaner (“You Have ## Share Opportunities Remaining”). The loaner may be presented with an offer 236 to purchase additional share opportunities (“I Would Like to Purchase More Share Opportunities”). If the loaner selects control 236, the user may be presented with one or more offers to purchase additional share opportunities associated with the item of electronic content, such as those shown in FIG. 5A, for example.

Offers may be presented at various times during the share event. For example, offers may be presented at the time the share event is initiated. As another example, offers may be presented after receipt of the share request. As another example, offers may be presented before the share request is approved or disapproved. As another example, offers may be presented after the share request is approved or disapproved. As another example, offers may be presented if it is determined that the loaner does not have any available share opportunities associated with the item of electronic content, while the same or other offers may be presented if it is determined that the loaner does have available share opportunities associated with the item of electronic content. As yet another example, additional offers may be presented after a content share offer is accepted or rejected, after a payment has been processed, or immediately before or after the item of electronic content has been transferred from the loaner device to the recipient device.

In some implementations, the price for share opportunities associated with the item of electronic content may be dynamically determined. For example, information may be determined about the user, a price for one or more share opportunities may be dynamically set based on the information determined about the user, and the offer may specify the dynamically set price. For example, it may be determined whether a user (either the loaner and/or the recipient) is more or less likely to share the item of electronic content than a typical user. The dynamic pricing techniques may also be applied to dynamic pricing of share opportunities associated with items of electronic content, as described herein, if desired.

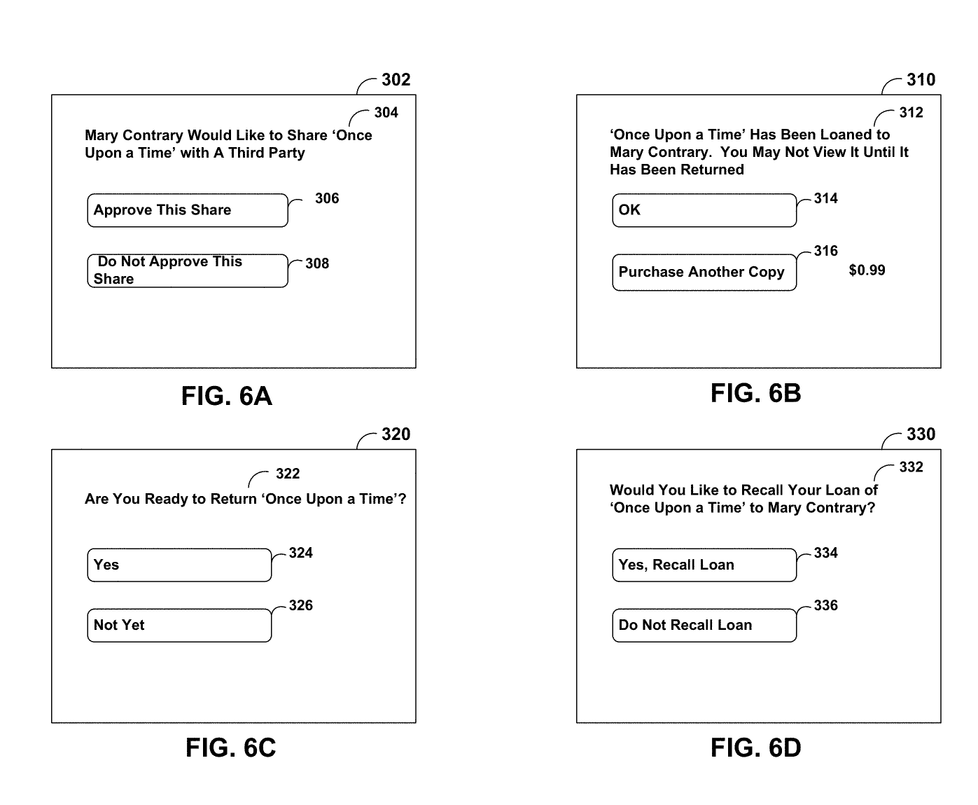

FIGS. 6A-6D are diagrams illustrating additional example user interfaces that may be presented to a loaner or a recipient after a share event has been completed. For example, assume that the original loaner (for example, a user of device 102A in FIG. 3) has completed a first share event that resulted in sharing a copy of the electronic book “Once Upon a Time” with a first recipient (Mary Contrary). At a subsequent time, the first recipient (for example, a user of device 102B in FIG. 3) attempts to share a copy of the item with a third party (for example, a user of device 102C in FIG. 3). In some examples, the offers shown in FIGS. 5A-5D may be presented during this subsequent share event. For example, if Mary Contrary had not previously purchased share opportunities associated with ‘Once Upon a Time,’ the offer 214 shown in FIG. 5B may be presented on Mary Contrary's device. Likewise, depending upon the selections made by Mary Contrary and/or the third party during the subsequent share event, different ones of the offers presented in any of FIGS. 5A-5D, or other offers, may be presented to one or both of them.

In other examples, the original loaner may be presented with an offer to either approve or disapprove of the subsequent share event request. For example and as shown in FIG. 6A, an offer 304 may be presented to the original loaner that would permit them to either approve (“Approve This Share” 306) or not approve (“Do Not Approve This Share” 308) the subsequent share event request. If the loaner selects control 306, the subsequent share request may be approved. At this point, an offer may be presented to the original loaner to either use one of their available share opportunities (if any) or to ask the first recipient to purchase a share opportunity in order to complete the subsequent share request, for example. If the loaner selects control 308, the content sharing management application may not approve the subsequent share request.

As another example and as shown in FIG. 6B, assume that the original loaner (for example, a user of device 102A in FIG. 3) has completed a first share event that resulted in sharing a copy of the electronic book “Once Upon a Time” with a recipient (Mary Contrary, in this example). At a subsequent time and before the first recipient has “returned” the book to the loaner, the loaner attempts to consume the item of electronic content (read the electronic book, “Once Upon a Time,” in this example). However, in this example, the loaner's share opportunities do not permit the loaner to consume the item while it has been loaned to another. In this example, the effect of sharing of the electronic book with another user is the same as the effect of loaning a real book to a friend; that is, the original owner of the book cannot read the book until the friend gives it back. An offer (such as offer 316 “Purchase Another Copy”) may be presented to the loaner to purchase an additional copy of the book. The offer may include a price ($3.99, in this example) or the price and/or other details of the offer may be presented on another screen by pressing control 316.

As another example and as shown in FIG. 6C, assuming that the recipient (e.g., a user of device 102B in FIG. 1, 2, or 3) is finished with the book “Once Upon a Time” and is ready to “return” the book. A return may be accomplished either manually or automatically. A manual return may be accomplished by initiating a share event with the loaner's device (e.g., by bumping or tapping the loaner's device, or by bringing the loaner and recipient devices into proximity). During this share event to manually return the item, the recipient may be presented with an offer 322 to return the item. For example, the recipient may select control 324 to automatically return the book. As another example, the recipient may select a control such as control 326 if they are not yet ready to return the book.

As another example, the recipient may be presented with an offer (not shown) to write or record a “thank you note” to the loaner. Such an offer could be attached to a price or could be provided free of charge.

Alternatively, the recipient may be presented with an offer 322 to return the item without initiating a share event. For example, the recipient may be presented with an offer to return the item after a predetermined period of time has elapsed since the loan was made. For example, the recipient may select control 324 to automatically return the book. As another example, the recipient may select a control such as control 326 if they are not yet ready to return the book.

As another example and as shown in FIG. 6D, the loaner may be presented with an offer to recall a loan of an item of electronic content. In this example, the loaner is presented with an offer 332 on an interface 330 to recall one such loan (“Would You Like to Recall Your Loan of ‘Once Upon a Time’ to Mary Contrary?). Such an offer may be presented, for example, after a predetermined period of time has elapsed since the share event during which the loan was made, at any time chosen by the loaner, after the recipient has failed to return the item a predetermined number of times, after each time the recipient has been presented with an offer to but refused to return the item, or at other appropriate times when a loaner may desire to recall a loan. The loaner may select a control such as control 334 (“Yes, Recall Loan”) to recall the loan or may select a control such as control 336 (“Do Not Recall Loan”) if they to not with to recall the loan.

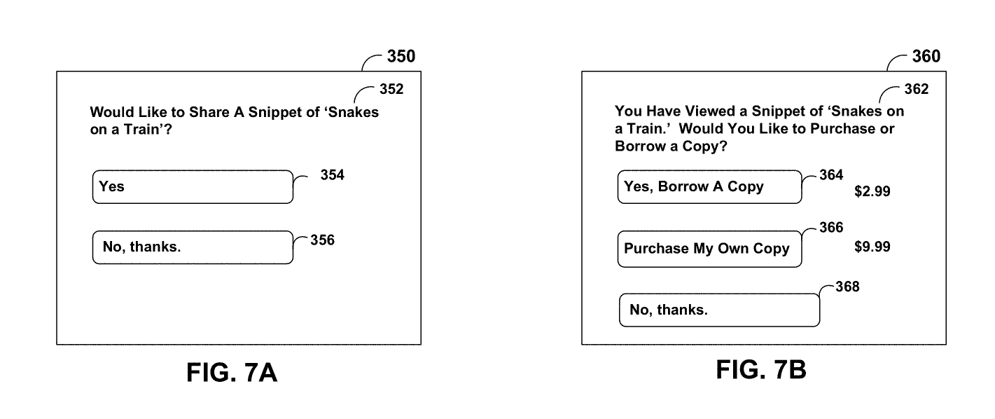

As another example and as shown in FIG. 7A, a loaner may share a selected portion of an item of electronic content with a recipient. That is, rather than sharing an entire item of electronic content, the loaner may choose to share a selected portion (a “snippet”) of the item of electronic content. Sharing of a snippet allows the recipient to experience an illustrative sample of the item. The recipient may then be able to judge whether or not to receive a shared copy of the item or to purchase their own copy.

In some examples, the selected portion of the item of electronic content may be selected through the loaner device. For example, the loaner (or recipient) may be able to choose a selected non-linear portion of the item using a control on the loaner device. The selected portion may be restricted in terms of size. For example, the size (either in terms of time, number of pages, percentage, etc. depending upon the type of media to be shared) of the selected portion will generally be smaller than the size of the entire item. As another example, the selected portion may be automatically chosen. For example, if the share event indicates that a snippet of an item of electronic content is to be shared, the share management system may automatically select a previously identified portion of the item. With a song, for example, a previously identified portion, such as the first 30 seconds or other previously identified time frame within the song may be automatically selected. With a book, for example, a particular chapter within the book or a certain previously identified number of pages within the book may be automatically selected. With a movie, for example, a particular scene within the movie, a portion of a particular scene within the movie, or the movie trailer may be automatically selected. With video game, for example, a particular scene, level, or experience within the game may be automatically selected. With an application, for example, a particular function or experience provided by the application may be automatically selected.

For example and as shown in FIG. 7A, the user may be presented with an offer, such as offer 352 on display 350 (“Would you Like To Share A Snippet of ‘Snakes on a Train’?”) to share a selected portion of an item of electronic content. The loaner may select a control such as control 354 (“Yes”) if they want to share the selected portion or may select a control such as control 356 (“No, thanks”) if they decide not to share the selected portion. An offer to share a snippet may be presented, for example, while the loaner is consuming the item of electronic content. An offer to share a snippet may be presented at a time when the user begins consumption of the item, when the user pauses consumption of the item, when the user returns to consumption of the item, or at one or more previously identified times or places during the consumption of the item.

In some examples, sharing of a selected portion of an item of electronic content may be done at no cost. Permitting no cost sharing of selected portions of an item of electronic content may increase total purchases and/or loans of the item. For example and as shown in FIG. 7B, an offer may be presented to the recipient of the selected portion (“snippet”) to either borrow or purchase the item of electronic content 362 (“You Have Viewed a Snippet of ‘Snakes on a Train.’ Would You Like to Purchase or Borrow a Copy?”). The recipient may select a control such as control 364 (“Yes, Borrow A Copy”) if they would like to borrow a copy of the item of electronic content. Alternatively, the recipient may select a control such as control 366 (“Purchase My Own Copy”) if they would like to purchase their own copy, or may select a control such as control 368 (“No, thanks”) if they decide they do not want to borrow or purchase a copy of the item of electronic content.

A number of example implementations have been described. Nevertheless, it will be understood that various modifications may be made without departing from the spirit and scope of the disclosure. For example, various forms of the flows shown above may be used, with steps re-ordered, added, or removed.

Aspects of the disclosure and all of the functional operations described in this application may be implemented in digital electronic circuitry, or in computer software, firmware, or hardware, including the structures disclosed in this application and their structural equivalents, or in combinations of one or more of them. Some or all of the components and functions described herein may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or device or distributed across multiple sites or devices and interconnected by a communication network.

The processes and logic flows described in this application may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The basic elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, some components described herein may be implemented on a computer having a display device, e.g., a CRT (cathode ray tube) or LCD (liquid crystal display) monitor or touch screen for displaying information to the user, a keyboard, a pointing device (e.g., a mouse or a trackball), or other mechanism by which the user may provide input to the device. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Aspects of the examples described herein may be implemented in a computing system that includes a back end component, e.g., as a data server, or that includes a middleware component, e.g., an application server, or that includes a front end component, e.g., a client computer having a graphical user interface or a Web browser through which a user may interact with various components, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this application contains many specifics, these should not be construed as limitations on the scope of the disclosure or of what may be claimed, but rather as descriptions of features specific to particular examples. Certain features that are described in this application in the context of separate aspects may also be implemented in combination in a single implementation. Conversely, various features that are described in the context of a single aspect may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products.

In some examples, an article of manufacture may comprise one or more computer-readable storage media.

In some examples, computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular example implementations have been described. Other implementations are within the scope of the following claims. As one example, the actions recited in the claims may be performed in a different order and still achieve desirable results.

1. A method comprising:
detecting, by a sensor of a loaner computing device, physical proximity between the loaner computing device and a recipient computing device associated with physical contact;
responsive to detecting the physical proximity associated with physical contact, determining, by the loaner computing device, whether communication with a remote computing device is available;
responsive to determining that communication with the remote computing device is available:
transmitting, by the loaner computing device and to a remote computing, a share request to share at least one item of electronic content associated with the loaner computing device with the recipient computing device;
receiving, by the loaner computing device and from the remote computing device, (i) a share information update indicating there are no remaining share opportunities associated with the item of electronic content and (ii) one or more content share offers associated with the item of electronic content;
outputting, by the loaner computing device and for display, a first user interface including the one or more content share offers to purchase additional share opportunities associated with the item of electronic content;
transmitting, by the loaner computing device and to the remote computing device, an indication of acceptance of the one or more content share offers based on user input to the user interface; and
receiving, by the loaner computing device and from the remote computing device, approval of the share request;
responsive to receiving the approval of the share request, transferring, from the loaner device to the recipient computing device, a copy of the item of electronic content;
after transferring the copy of the item of electronic content, outputting, by the loaner computing device and for display, a second user interface including a graphical element indicative of an offer to recall the copy of the item of electronic content; and
responsive to receiving a user input selecting the graphical element of the offer to recall the copy of the item of electronic content, recalling the copy of the item of electronic content.

2. The method of claim 1, further comprising:
outputting, by the loaner computing device and for display, a first control option indicating a user of the recipient computing device is to pay for the content share offer associated with the item of electronic content and a second control option indicating a user of the loaner computing device is to pay for the content share offer; and
receiving, by the loaner computing device, an indication as to whether or not the one or more content share offers has been accepted and user input of at least one of the first control option and the second control option.

3. The method of claim 1, further comprising:
responsive to determining communication with the remote computing device is not available:
determining, by the loaner computing device, a number of remaining share opportunities associated with the item of electronic content based on locally stored share opportunity data; and
approving the share request in response to determining the remaining number of share opportunities is greater than zero.

4-9. (canceled)

10. The method of claim 1,
wherein the one or more content share offers includes a price dynamically set based on information about a user of the loaner computing device.

11. The method of claim 1, wherein the item of electronic content comprises at least one of an audio recording, a video recording, a video game, an e-book, a ring tone, and an electronic wallpaper.

12-13. (canceled)

14. The method of claim 1, further comprising:
transmitting, by the loaner device and to the remote computing device, information identifying the loaner computing device and the recipient computing device,
wherein the approval of the share request is based on the information identifying the loaner computing device and the recipient computing device.

15. (canceled)

16. The method of claim 1, wherein outputting the first user interface including the one or more content share offers further comprises:
outputting, by the loaner computing device and for display, the one or more content share offers including one or more pricing options, wherein each pricing option is based on a specified quantity of share opportunities.

17. The method of claim 16, wherein the one or more pricing options comprises:
a first price for a lower number of share opportunities; and
a second price for a higher number of share opportunities,
wherein the first price for the lower number of share opportunities is lower than the second price for the higher number of share opportunities.

18. The method of claim 1, wherein outputting the first user interface including the one or more content share offers further comprises:
outputting, by loaner remote computing device and for display, the one or more content share offers associated with a group of items of electronic content.

19. A non-transitory computer-readable storage medium comprising instructions that cause one or more processors of a loaner computing device to perform operations comprising:
detecting physical proximity between the loaner computing device and a recipient computing device associated with physical contact;
responsive to detecting the physical proximity associated with physical contact, determining whether communication with a remote computing device is available;
responsive to determining that communication with the remote computing device is available:
transmitting, to a remote computing, a share request to share at least one item of electronic content associated with the loaner computing device with the recipient computing device;
receiving, from the remote computing device, (i) a share information update indicating there are no remaining share opportunities associated with the item of electronic content and (ii) one or more content share offers associated with the item of electronic content;
outputting, for display, a first user interface including the one or more content share offers to purchase additional share opportunities associated with the item of electronic content;
transmitting, to the remote computing device, an indication of acceptance of the one or more content share offers based on user input to the first user interface;
receiving approval of the share request; and
responsive to receiving the approval of the share request, transferring, from the loaner device to the recipient computing device, a copy of the item of electronic content;
after transferring the copy of the item of electronic content, outputting, for display, a second user interface including a graphical element indicative of an offer to recall the copy of the item of electronic content; and
responsive to receiving a user input selecting the graphical element of the offer to recall the copy of the item of electronic content, recalling the copy of the item of electronic content.

20. A computing device comprising:
at least one processor;
a memory storing one or more applications including a content share application;
at least one sensor configured to detect physical proximity between the computing device and a recipient computing device associated with physical contact;
wherein the at least one processor executes the content share application to:
responsive to detecting the physical proximity associated with physical contact, determining whether communication with a remote computing device is available;
responsive to determining that communication with the remote computing device is available:
transmit, to a remote computing device, a share request to share at least one item of electronic content associated with the computing device with the recipient computing device;
receive, from the remote computing device, (i) a share information update indicating there are no remaining share opportunities associated with the item of electronic content and (ii) one or more content share offers associated with the item of electronic content;
output a first user interface including the one or more content share offers to purchase additional share opportunities associated with the item of electronic content;
transmit, to the remote computing device, an indication of acceptance of the one or more content share offers based on user input to the first user interface;
receive approval of the share request; and
responsive to receiving the approval of the share request, transfer, to the recipient computing device, a copy of the item of electronic content;
after transferring the copy of the item of electronic content, outputting, for display, a second user interface including a graphical element indicative of an offer to recall the copy of the item of electronic content; and
responsive to receiving a user input selecting the graphical element of the offer to recall the copy of the item of electronic content, recalling the copy of the item of electronic content.

21. The method of claim 1 wherein detecting physical proximity between the computing device and a recipient computing device associated with physical contact comprises:
detecting, by the sensor of the computing device, physical contact between (i) at least one of: the computing device and a hand holding the computing device and (ii) at least one of the recipient computing device and a hand holding the recipient computing device.

22. The computing device of claim 20 wherein the at least one sensor includes at least one of an accelerometer, a gyroscope, a magnetometer, and a contact-sensitive sensor.

23. The computing device of claim 20 wherein the at least one sensor includes a proximity sensor.

24. The computing device of claim 20, wherein the at least one processor further executes the content share application to:
output, for display, a first control option indicating a user of the recipient computing device is to pay for the content share offer associated with the item of electronic content and a second control option indicating a user of the computing device is to pay for the content share offer; and
receive an indication as to whether or not the one or more content share offers has been accepted and user input of at least one of the first control option and the second control option.

25. The computing device of claim 20, wherein the at least one processor further executes the content share application to:
responsive to determining communication with the remote computing device is not available:
determine a number of remaining share opportunities associated with the item of electronic content based on share opportunity data locally stored in the memory; and
approve the share request in response to determining the remaining number of share opportunities is greater than zero.

26. The computing device of claim 20, wherein the at least one processor executing the content share application to output the user interface including the one or more content share offers is further configured to:
output, for display the one or more content share offers including one or more pricing options, wherein each pricing option is based on a specified quantity of share opportunities.

27. The computing device of claim 20, wherein the item of electronic content comprises at least one of an audio recording, a video recording, a video game, an e-book, a ring tone, and an electronic wallpaper.

28. The method of claim 1, wherein determining whether to output the offer to recall the loan of the item of electronic content comprises determining, by the computing device, that a predetermined amount of time has elapsed since transferring the copy of the item of electronic content to the recipient computing device.
